(19) United States
(12) Patent Application Publication
(10) Pub. No.: US 2008/0094309 A1
(43) Pub. Date: Apr. 24, 2008

(54) Dielectric Resonator Radiators

(75) Inventors: Kristi Dhimiter Pance, Auburndale, MA (US); Jean-Pierre Lanteri, Waltham, MA (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-Com, Inc., Lowell, MA (US)

(21) Appl. No.: 11/551,798

(22) Filed: Oct. 23, 2006

(51) Int. Cl. H01Q 15/02

(52) U.S. Cl. 343/911 R

(57) ABSTRACT

A dielectric resonator radiator comprising first and second portions, each portion being conical or monotonically varying in shape having a larger basal surface and a smaller basal surface and defining a longitudinal axis, the first and second portions being arranged with their longitudinal axes collinear and their larger basal surfaces parallel and adjacent to each other and separated by a gap.

### BACKGROUND

1. Field of the Invention

The invention pertains to dielectric resonator radiators. More particularly, the invention pertains to dielectric resonators that can be used as antennas and the like in various communication systems, such as microwave communication systems.

2. Background of the Invention

Dielectric resonators are used widely in telecommunications equipment as filters and other circuit elements because of their very high quality factor, Q, and thus low losses, particularly in the microwave frequency spectrum. In such circuits, the dielectric resonators traditionally are enclosed within a conductive enclosure wherein the electromagnetic fields are highly concentrated and contained. (Of course, these circuits have input and output couplers and, therefore, are not completely closed).

As a result of the very high Qs and highly concentrated electromagnetic fields of these circuits, it was originally thought that dielectric resonators would not be well-suited for use as broadband antennas or radiators. More specifically, in order to radiate broadband (e.g. 15 to 20% bandwidth), the resonance of the dielectric resonator must be somewhat weak. However, because of the very high Qs achieved in dielectric resonator filter circuits and other circuits, it was believed that dielectric resonator radiators generally would have a narrow bandwidth.

It has been discovered, however, that the low order modes, particularly the TE_{01δ} (hereinafter TE or Transverse Electric) and TM (Transverse Magnetic) modes might radiate broadband.

Accordingly, it is an object of the present invention to provide an improved dielectric resonator radiator.

### SUMMARY OF THE INVENTION

A dielectric resonator radiator comprising first and second portions, each portion being conical or monotonically varying in shape having a larger basal surface and a smaller basal surface and defining a longitudinal axis, the first and second portions being arranged with their longitudinal axes collinear and their larger basal surfaces parallel and adjacent to each other and separated by a gap. Preferably, the resonator includes a longitudinal through hole in the shape of two cones or other monotonically varying shapes arranged collinear with their smaller basal surfaces adjacent and parallel to each other.

In accordance with another aspect of the invention, a dielectric resonator radiator is provided comprising a dielectric resonator body defining a longitudinal direction perpendicular to a direction of an electrical field of a fundamental mode of the resonator and a transverse direction parallel to the field, the resonator body having first and second longitudinal ends, an outer side wall connecting the first and second longitudinal ends, a cross-section in the transverse direction that decreases monotonically between an intermediate transverse plane passing through the resonator and the first longitudinal end and decreases monotonically between the intermediate transverse plane and the second longitudinal end and further comprising a transverse gap intermediate the first and second longitudinal ends.

In accordance with yet another aspect of the invention, a dielectric resonator radiator is provided comprising a conical dielectric material body having a longitudinal axis, a larger basal surface, and a smaller basal surface transverse the longitudinal axis and a first planar reflector adjacent and parallel to the larger basal surface and separated therefrom by a gap.

In accordance with a further aspect of the present invention a dielectric resonator radiator is provided comprising a conical dielectric material body having a longitudinal axis, a larger basal surface, and a smaller basal surface transverse the longitudinal axis and a planar reflector parallel to the longitudinal axis and adjacent the conical dielectric material body.

### BRIEF DESCRIPTION OF THE DRAWINGS

FIGS. 1A and 1B are perspective and elevation cross sectional views respectively of a dielectric resonator radiator in accordance with the principles of the present invention.

FIG. 1C is a elevation cross sectional view of an alternate embodiment of a dielectric resonator radiator in accordance with the principles of the present invention.

FIGS. 2A and 2B are perspective and elevation cross sectional views, respectively, of an alternative embodiment of a dielectric resonator radiator in accordance with the principles of the present invention.

FIG. 3 is an elevation cross sectional view of another alternative embodiment of a dielectric resonator radiator in accordance with the principles of the present invention.

FIG. 4 is an elevation cross sectional view of yet another alternative embodiment of a dielectric resonator radiator in accordance with the principles of the present invention.

FIG. 5 is an elevation cross sectional view of a further alternative embodiment of a dielectric resonator radiator in accordance with the principles of the present invention.

FIGS. 6A and 6B are perspective and elevation cross sectional views, respectively, of one more alternate embodiment of a dielectric resonator radiator in accordance with the principles of the present invention.

FIG. 7 is a elevation cross-sectional view of still a further alternative embodiment of a dielectric resonator radiator in accordance with the principles of the present invention.

FIG. 8 is an elevation cross sectional view of yet one more alternative embodiment of a dielectric resonator radiator in accordance with the principles of the present invention.

FIG. 9 is an elevation cross sectional view of another alternative embodiment of a dielectric resonator radiator in accordance with the principles of the present invention.

FIG. 10 is a perspective view of another alternative embodiment of a dielectric resonator radiator in accordance with the principles of the present invention.

FIG. 11 is a perspective view of a further alternative embodiment of a dielectric resonator radiator in accordance with the principles of the present invention.

FIGS. 12A and 12B are perspective and elevation cross sectional views, respectively, of one more alternative embodiment of a dielectric resonator radiator in accordance with the principles of the present invention.

FIG. 13 is an elevation view of a further alternative embodiment of a dielectric resonator radiator in accordance with the principles of the present invention.

### DETAILED DESCRIPTION OF THE INVENTION

The invention is a dielectric resonator radiator comprising two generally conical or otherwise longitudinally monotonically varying dielectric resonator body portions having a larger basal surface and a smaller basal surface inverted relative to each other and separated by a transverse gap. The two resonator body portions are arranged with their larger basal surfaces facing each other. As used herein, the terms larger basal surface and smaller basal surface are used relatively to each other, i.e., the larger basal surface is larger than the smaller basal surface. The two resonator body portions collectively form a resonator that can be used as a radiator as fully described herein. The gap is filled with air, vacuum, or a relatively lower dielectric constant substrate. In a preferred embodiment, the gap is filled with a substrate that has a variable dielectric constant, such as might be changed by applying a voltage across it. In a preferred embodiment, there is a longitudinal through hole running through the resonator radiator, the through hole in each dielectric resonator body portion also being longitudinally monotonically varying in opposite directions to each other, but with their smaller longitudinal ends adjacent to each other. For instance, the through hole may have the shape of two truncated cones placed end to end and inverted relative to each other, with their smaller basal surfaces facing each other.

In elevational cross-section, the outline of the above-described resonator radiator would have the general shape of a diamond, whereas the internal walls defining the through hole generally would have the shape of an X.

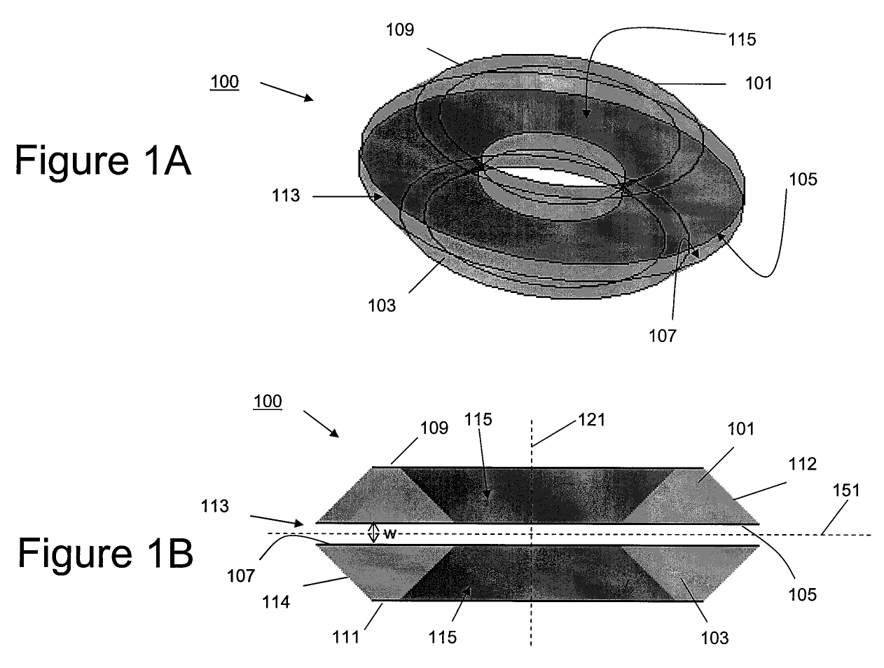

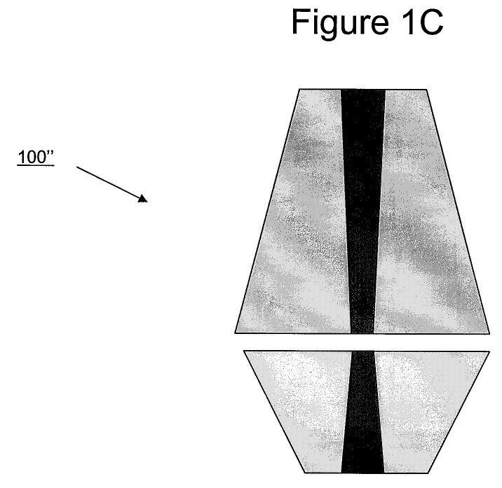

FIGS. 1A and 1B are perspective and elevational cross-sectional views of an exemplary dielectric resonator radiator 100 in accordance with the principles of the present invention. The resonator comprises two dielectric resonator material body portions 101, 103. These resonator body portions may be formed of any suitable dielectric resonator material. In at least one preferred embodiment, the resonator material has a dielectric constant of at least 45. It may be formed of barium tatinate, for instance.

In this embodiment, the two resonator body portions 101, 103 are identical to each other (and positioned in mirror image to each other). While it is preferred that the two resonator body portions are identical and such embodiments generally will provide the best performance, it is not necessary.

Each resonator body portion 101, 103 is in the shape of a truncated cone. Each of the truncated cones has a larger basal surface 105, 107 and a smaller basal surface 109, 111. The two portions 101, 103 are longitudinally aligned with each other, i.e., their central longitudinal axes are coaxial along line 121.

The larger basal surfaces 105, 107 preferably are parallel and are separated by a gap 113 running in a transverse direction. The gap may be filled with air, a vacuum, or a dielectric material having a lower dielectric constant than the material of portions 101, 103.

The width, w, of the gap significantly affects (and therefore should be selected based primarily upon) the desired spurious response, the desired bandwidth of the antenna, and an efficient excitation of the operational mode. A larger gap can support an efficient excitation of the desired operational mode. Specifically, the larger the gap, the more field will exist outside of the resonator bodies. This leads to more efficient excitation of the fundamental mode and a broader bandwidth.

The resonator radiator 100 preferably comprises a longitudinal through hole 115. Preferably, the longitudinal through role 115 also has the shape of two longitudinally aligned, truncated cones, but with their smaller longitudinal ends parallel and facing each other, i.e., they are inverted relative to the conical slope of the outer wall 112, 114 of the dielectric resonator body portion 101, 103 within which they are disposed. If the transverse gap 113 is filled with a dielectric substrate, the through hole may, but need not, be bored through the substrate material also.

This shape dielectric resonator is particularly suited to radiating in the fundamental modes, particularly the TE_{01δ}, mode (hereafter TE mode). Specifically, the TE mode is a pure dipole mode, i.e., the poles of this mode are aligned on the central longitudinal axis 121 of the resonator. The TE mode is a magnetic dipole, i.e., the magnetic poles are aligned along the longitudinal axis of the resonator. Except for the TM mode, which is an electric dipole, the other modes of the resonator have two or more dipoles concentrated in the same dielectric resonator (always appearing in pairs, i.e., 2, 4, 6, etc. dipoles per resonator). In such cases, the associated pairs of dipoles tend to cancel each other in the far field, making dielectric resonators generally unsuitable for use as radiators in connection with the higher order modes.

The double conical (or diamond) shape of the outer wall of the resonator radiator, the transverse gap, and the reverse double conical shape of the through hole all provide significant advantages in terms of suppressing spurious response and providing a good radiator.

Particularly, the transverse gap 113 provides an area of low dielectric constant in the middle of the resonator, near the larger basal surfaces of the high dielectric constant material of the resonator body portions 101, 103. As discussed in detail in U.S. Patent Application Publication No. 2004/0051602, which is incorporated herein fully by reference, in a conical resonator, the field concentration of the various modes in the resonator vary as a function of the longitudinal dimension. Taking the fundamental TE mode for example, it tends to concentrate in and near the larger diameter portion of the truncated conical resonator body portions, i.e., near the larger basal surfaces 105, 107 adjacent the gap 113. By contrast, the H₁₁ mode, which typically is the next lowest order mode and the mode that most often is of concern with respect to spurious response, tends to concentrate in the smaller diameter portion of the conical body, i.e., closer to the smaller basal surface 109, 111. Thus, the double reverse conical outer profile of the resonator radiator of FIGS. 1A and 1B causes the H₁₁ mode field to be well separated physically from the TE mode, providing good spurious response.

As described in the aforementioned Patent Application Publication No. 2004/0051602, the conical resonator is merely a single example of a broader class of shapes having these desirable properties. More broadly stated, resonators that have a transverse cross-sectional area (i.e., the section being taken perpendicular to the longitudinal axis of the resonator or parallel to the field lines of the TE mode) that varies monotonically along the longitudinal direction of the resonator. By monotonically it is meant that the cross-section of the resonator body portion changes in only one direction, i.e., increases or decreases as a function of increasing height from one of the longitudinal ends of the resonator. However, the term also encompasses shapes for which the cross section remains constant over sub-sections of the resonator body's height, but generally varies monotonically, such as a plurality of stacked cylinders, in which each cylinder has a smaller diameter than the cylinder it is sitting on. A conical resonator, of course, meets this criterion perfectly since its diameter decreases linearly as a function of height (while its cross section decreases geometrically as a function of height). However, many other shapes are possible, such as a stepped cone, a hemisphere, and a stepped cylinder. Furthermore, strict adherence to monotonic variation is not a necessity. Specifically, shapes that mimic such monotonic variation on the large-scale, but do not necessarily strictly adhere to it on the small-scale provide essentially similar performance. For instance, a plurality of stacked toroids of decreasing diameters, like a beehive as discussed in more detail later in this specification, are quite effective also.

Likewise, the double reverse conical shape of the longitudinal through hole shown in FIGS. 1A and 1B also is merely exemplary. Again, the through hole may be stepped or curved in profile or need not strictly adhere to the monotonic variation trait on the small-scale, as discussed in more detail later in this specification.

The provision of the transverse gap 113 in the middle of the resonator radiator near the adjacent larger basal surfaces 105, 107 provides a transverse volume of low dielectric constant near where the TE mode is concentrated in the high dielectric constant material of the resonator body portions 101, 103. This is desired in order to provide a good radiator. The gap serves the function of both providing strong radiation and causing that radiation to have a broad bandwidth (because it reduces the Q of the circuit. Generally, the larger the gap width, w, the lower the Q of the circuit, and hence the wider the bandwidth.

The transverse gap 113 also has the significant advantage of being transverse to the electrical field lines of the H₁₁ mode, thus almost entirely suppressing that mode. This is a significant advantage because spurious response in dielectric resonator radiator antennas, and particularly the H₁₁ mode which usually is the next lowest frequency mode after the TE mode, is a substantial concern in such radiators.

The longitudinal through hole, and particularly the reverse double cone shape thereof, in which more material is removed closer to the longitudinal ends 109, 111 of the resonator than near the longitudinal middle of the resonator, strongly suppresses or eliminates the transverse magnetic, TM, dipole. Particularly, the TM mode electrical field lines tend to be oriented along the longitudinal direction of the resonator at and near the central longitudinal axis 121 of the resonator. The field lines are most concentrated longitudinally in the middle of the resonator and are less concentrated as one approaches the longitudinal ends 109, 111 of the resonator. They also take on an angle relative to the longitudinal axis 121 of the resonator. This approximately mirrors the shape of the through hole of the exemplary resonator of FIGS. 1A and 1B. Accordingly, this through hole shape tends to suppress or completely eliminate the TM mode, thus even further improving spurious response.

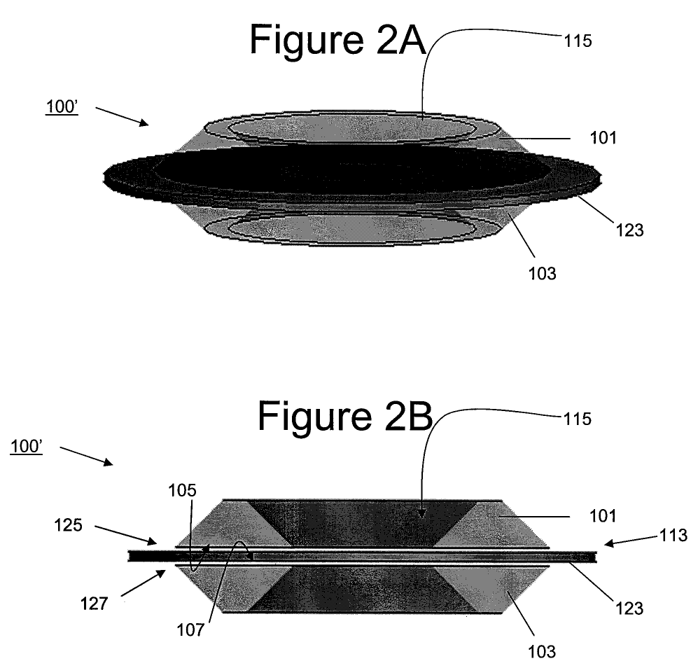

In one preferred embodiment of the invention illustrated in FIGS. 2A and 2B, a disc of dielectric material 123 having a dielectric constant of about 1-10 is inserted in the gap 113 between the two dielectric resonator body portions 101, 103. This embodiment is identical to the embodiment of FIGS. 1A and 1B, except for the addition of disc 123. The diameter of the disc preferably is equal to or greater than the diameter of the larger basal surfaces 105, 107 of the two resonator body portions 101, 103. The incorporation of such a disc has several advantages. First, it makes the resonator radiator 100′ easy to manufacture because the two resonator body portions 101, 103 and the disc 123 can simply be glued together (see adhesive layers 125, 127) to form the complete resonator radiator 100′. This would greatly simplify the step of precisely positioning the resonator body portions next to each other with parallel, slightly spaced apart basal surfaces to provide the gap 113. Particularly, simply laying the body portions 101, 103 on opposite sides of the disc 123 would inherently achieve the desired relative positioning of the portions. Second, the disc 123 can be made of a dielectric material the dielectric constant, ε, of which can be varied. Such materials are known. For instance, materials are known the dielectric constant of which can be varied by applying a voltage across it. This provides added flexibility in terms of tuning the radiator 100 by varying the voltage applied across the disc 123.

In a preferred embodiment of the invention, the coupling element (not shown) that will provide the energy into the resonator radiator 100, 100′ is positioned in the gap. In fact, it can even be embedded inside or on disc 123. The coupling element can be a conventional coupling loop, a microstrip coupler embodied on a substrate such as a PCB (printed circuit board), or any other conventional coupling element used in connection with dielectric resonators and similar circuits.

An important factor in the superior operational properties of the present invention is the fact that the dielectric resonator material is symmetric relative to the electric field lines of the mode of interest, in this case the fundamental TE_{01δ} mode.

Hence, preferably, not only is each of the two resonator body portions symmetric about its longitudinal axis 121, but the two resonator body portions also form a mirror image of each other about a transverse plane intermediate the two longitudinal ends of the radiator, e.g., plane 151. While preferred, symmetry is not required. For instance, it is possible to displace this intermediate plane from the exact midpoint between the two ends and to have a resonator radiator that is not perfectly symmetric about that plane, such as radiator 100″ illustrated in FIG. 1C. Alternately, the two portions need not even have the same shape. For instance, one may be a cone and the other may be a half torroid or a hemisphere.

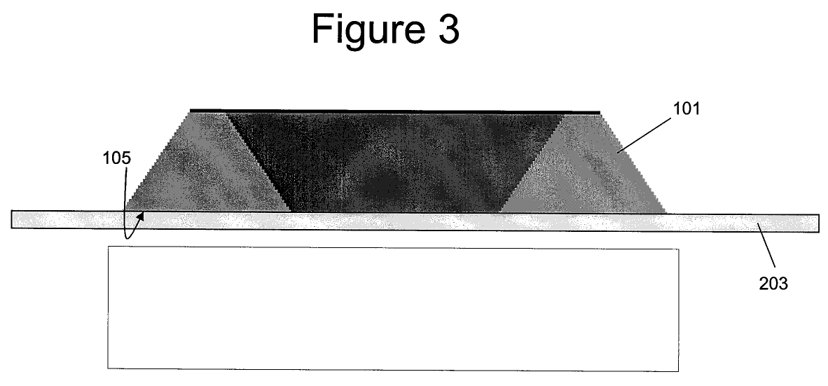

On the other hand, since the resonator preferably is a mirror image about the central transverse plane thereof, (i.e, the middle of the gap 113), it is possible to achieve essentially the same operation using only the top portion 101 of the resonator and a reflector 203 defining a conductive transverse plane adjacent and parallel to the larger basal surface 105, as shown in FIG. 3.

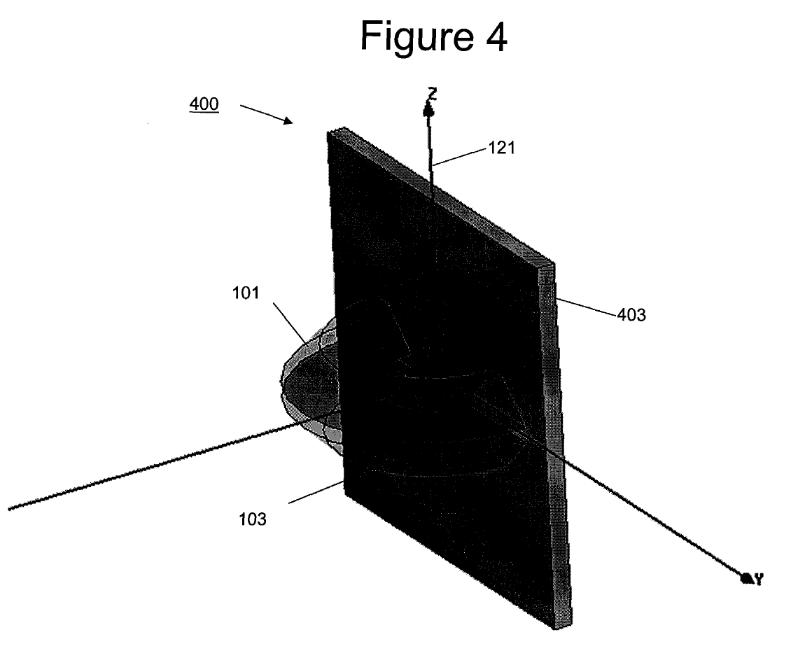

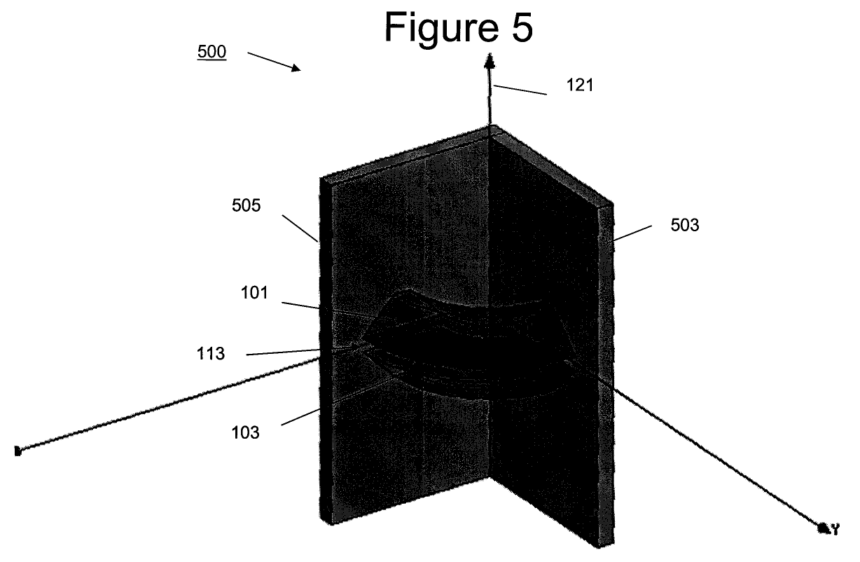

In fact, since the resonator radiator also is essentially a mirror image about a plane passing through the longitudinal axis of the radiator, essentially equivalent performance can be obtained by cutting the radiator in half in the longitudinal direction and providing a vertical reflector 403, such as shown in FIG. 4. In fact, the radiator can be cut in both of the aforementioned directions and positioned adjacent two reflectors. Even further, the radiator can be cut by two orthogonal vertical reflectors 503, 505, as shown in FIG. 5, for example, while retaining essentially equivalent performance.

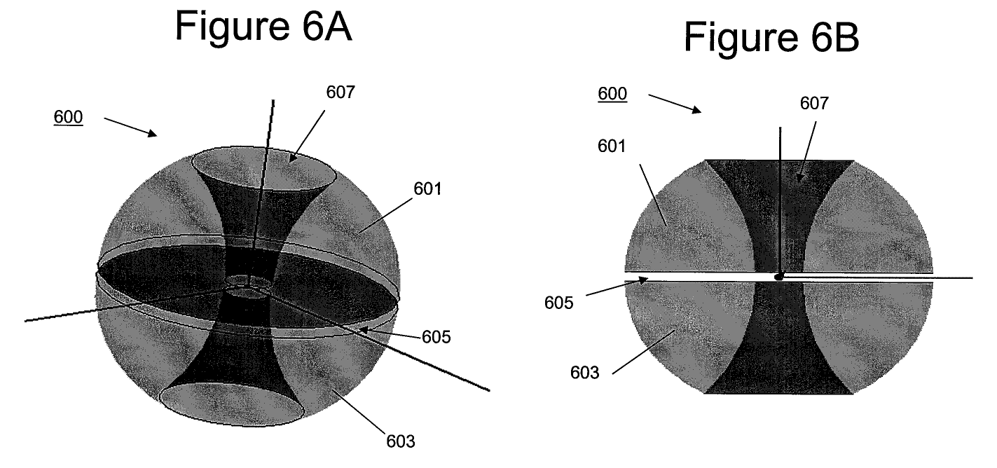

FIGS. 6A and 6B illustrate another preferred embodiment of the invention. In this embodiment, the resonator radiator 600 also comprises two body portions 601, 603, each body portion comprising a hemisphere. As before, the two body portions are separated by a transverse gap 605, which may be filled with air, vacuum, or a lower dielectric constant material than the material of the body portions 601, 603. The longitudinal through hole 607 also may be hyperbolic or similarly curved as shown in FIG. 6 so as to even more closely mimic the shape of the electrical field lines of the H₁₁ mode in order to suppress it. The curved longitudinal through hole may also be applied to any of the other embodiments of the invention discussed herein.

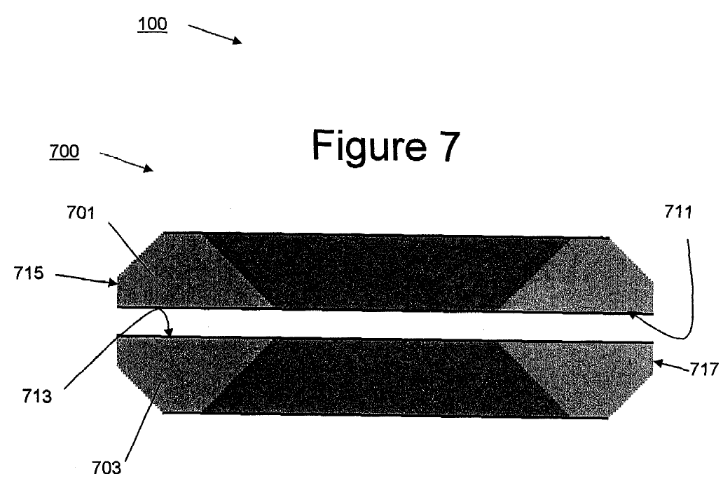

FIG. 7 illustrates another embodiment of a resonator radiator 700 in accordance with the principles of the present invention. In this embodiment, the radially outermost sections 715, 717 of the bases 711, 713 of the conical resonator body portions 701, 703 are removed so that the bases of the resonator body portions have rectangular profiles rather than triangular profiles. This embodiment has several advantages. It reduces the size of the resonator. Also, it allows more of the TE mode field to exist outside of the dielectric material and thus may provide even stronger radiation.

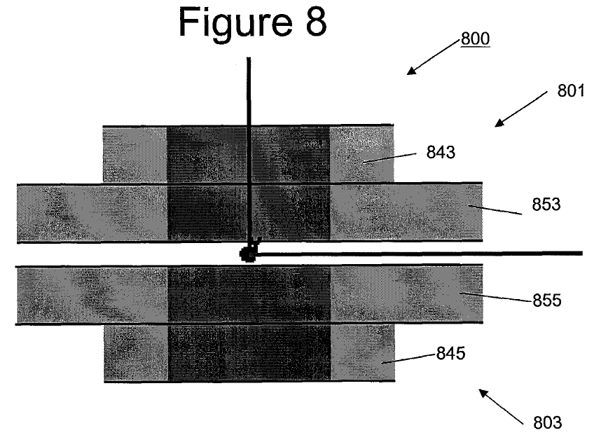

FIG. 8 is a perspective view of another embodiment of a dielectric resonator radiator 800 in accordance with the present invention. In this embodiment, the resonator body portions 801, 803 are stepped, each substantially comprising a longitudinally outer cylinder 843, 845 having a smaller radius and a longitudinally inner cylinder 853, 855 having a larger radius. This configuration has a similar effect as the configuration shown in FIGS. 1 and 2 in that it longitudinally displaces the H₁₁ mode from the TE mode. Particularly, the H₁₁ mode appears in and adjacent the outer smaller cylinders 843, 845, while the TE mode is concentrated in the inner, wider cylinders 853, 855 of the resonator radiator.

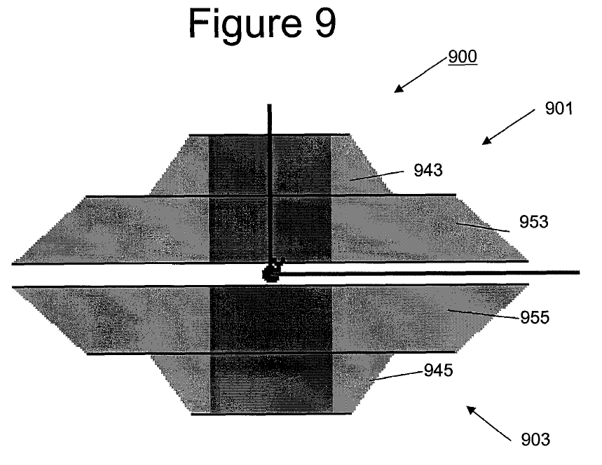

In another embodiment, illustrated in FIG. 9, each body portion 901, 903 of the resonator radiator 900 may comprise a stepped cone generally comprising two or more discontinuous truncated conical portions 943, 945 and 953, 955.

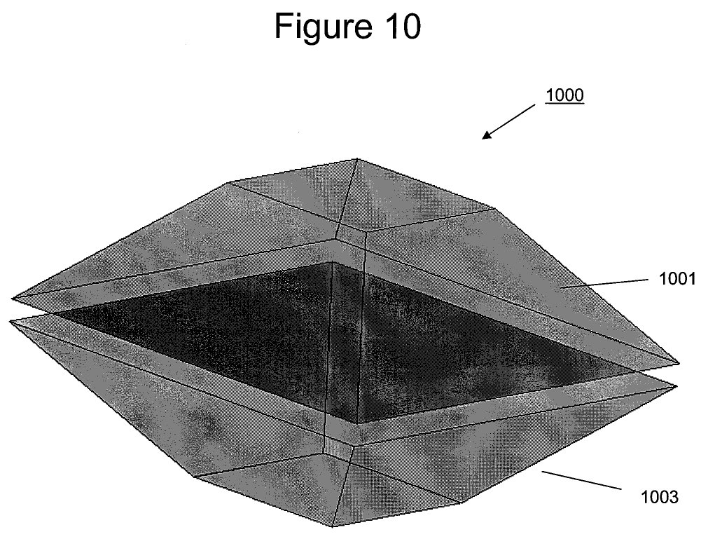

A substantial portion of the benefit of the present invention is derived from the change in size in the resonator body portions as a function of height. Accordingly, resonator body portions of many shapes other than a pure cone can provide most, if not all, of the benefits associated with the present invention. For instance, the sloped side of the resonator body portion may comprise multiple planar walls rather than one continuous conical wall. Specifically, referring to FIG. 10, a resonator radiator 1000 in accordance with the present invention may be formed as two longitudinally aligned truncated rectangular pyramids 1001, 1003 (i.e., each comprising four sloped, planar side walls). In order not to obfuscate the illustration of the shape of the outer surface of the dielectric resonator body portions, FIG. 10 does not show a longitudinal through hole. However, it will be understood that a longitudinal through hole may be included. The through hole may have any shape such as any of the shapes previously illustrated.

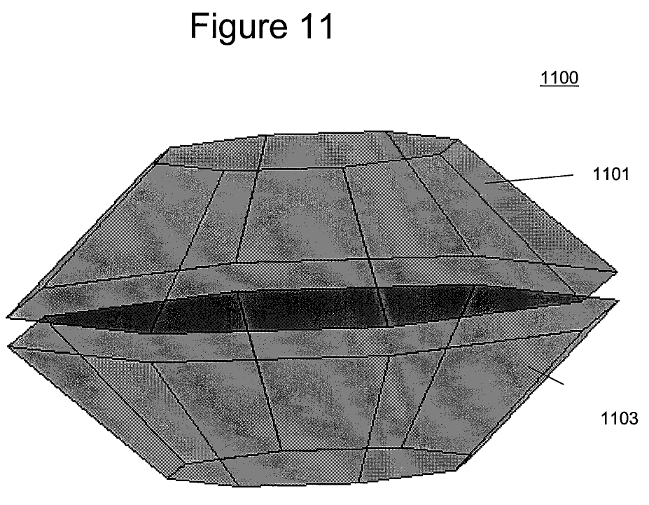

The resonator body portions may have more or less than four side walls. For instance, the resonator body portions may be truncated hexagonal pyramids 1101, 1103, as shown in FIG. 11.

The through hole in each body portion 1001, 1003 or 1101, 1103 may have essentially the same profile as the outer surface of the resonator body portion, but inverted (e.g., as in the embodiments of FIGS. 1A and 1B and 2A and 2B). Thus, in the FIG. 10 embodiment, it may be a truncated, four-walled pyramid inverted relative to the outer surface of the corresponding body portion 1001, 1003.

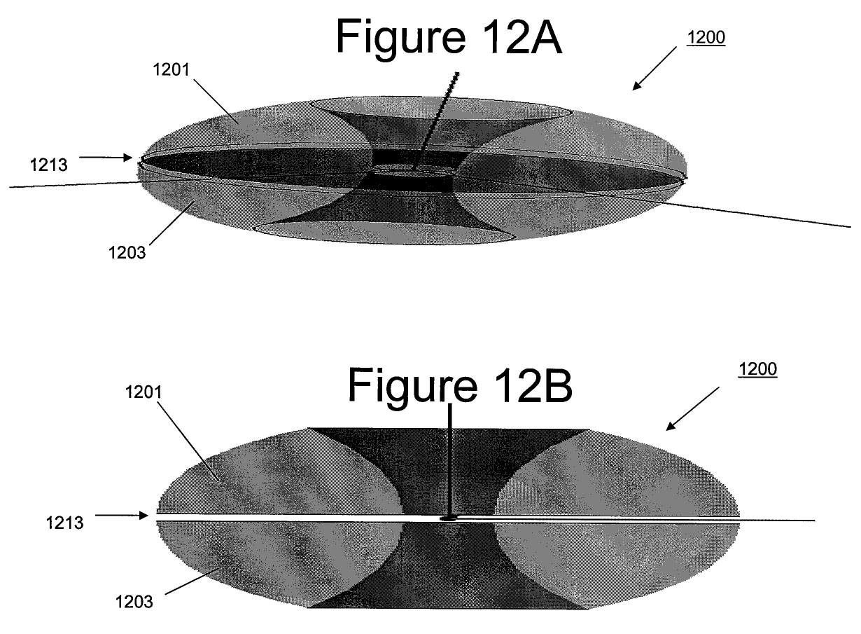

FIG. 12 illustrates a further embodiment of a resonator radiator 1200 in accordance with the present invention. Specifically, it has been found that two half-torus shaped body portions 1201, 1203 separated by a gap 1205 provides excellent performance. The resonator radiator 1200 has the overall shape of a bagel (or donut) sliced in half. This overall shape heavily supports the fundamental mode and causes the higher order modes to be spaced very far away in frequency from the fundamental mode, i.e., it provides excellent spurious response. However, a half torroid is a difficult and expensive shape to manufacture. The diamond shape provided by two conical resonator body portions placed end to end with their larger basal surfaces adjacent to each other such as shown in FIGS. 1A and 1B, provides a good first order approximation of a split torroid.

The specific dimensions of the resonator body portions and through holes should be selected based primarily on spurious response and will vary from design to design depending on the desired center frequency and bandwidth. Generally, the larger the diameter of the through hole and/or the larger the gap, the better the spurious response.

The pyramidical embodiments, such as illustrated in FIGS. 10 and 11, are less preferred than the other illustrated embodiments because these pyramidical shapes do not respect the symmetry relative to the fundamental TE mode as well as some of the other illustrated shapes, i.e., they are not symmetric about the longitudinal axis of the resonator.

Even further, while FIGS. 8 and 9 illustrate stepped cylinders and stepped cones, having a single step (i.e., two cylinder portions per half), the resonator radiator may have any number of steps.

In any of the aforementioned embodiments, the outer portion of the wall at the base of the resonator body portion may be squared-off in the manner illustrated in the FIG. 7 embodiment.

Furthermore, as discussed above, the purpose of the longitudinal through hole generally is to suppress the TM mode. In applications in which suppression of the TM mode is not of paramount importance, the longitudinal through hole may be eliminated. An aspect of the present invention is that the cross-sectional area of the resonator parallel to the electric field lines of the TE mode (i.e., the horizontal direction in all of the figures) has an area that varies in the direction perpendicular to the field lines of the TE mode (i.e., the vertical direction or height in all of the figures). Preferably, and in all of the embodiments discussed so far, the cross-sectional area of each resonator body half (or portion) varies monotonically as a function of height. Stated in less scientific terms, the amount of dielectric material in the resonator body portion generally decreases as a mathematical function of height. In the stepped cylindrical embodiments shown in FIG. 8, the area is constant over portions of the height, but decreases in discrete steps as one moves upwardly. In the conical embodiment of FIG. 7 in which the bottommost, outermost portion is cut off, the cross-sectional area is constant over a small portion of the height at the bottom of the resonator body portion and then decreases generally in accordance with the above formula for a cone.

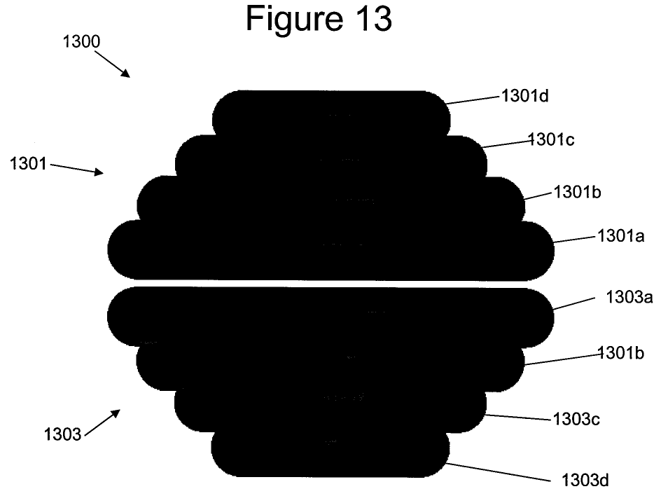

As mentioned above, much of the benefit of the present invention can be obtained even if the variation in cross-sectional area as a function of height is not truly monotonic on the small scale, but generally varies in one direction as a function of height on the large scale. For instance, FIG. 13 shows a resonator radiator 1300 in which each resonator body portion 1301, 1303 is generally in the shape resembling a beehive comprising a plurality of torroids 1301a-1301d, 1303a-1303d of decreasing diameters stacked on top of each other in which the resonator body portion's horizontal cross-sectional area generally decreases with increasing height, but includes portions where the cross-sectional area increases over small height increments.

Any of the alternate embodiments can also be used in conjunction with the reflector technique as illustrated in FIGS. 4 and 5.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A dielectric resonator radiator comprising first and second portions of dielectric material, each portion being conical in shape having a larger basal surface and a smaller basal surface and defining a longitudinal axis, said first and second portions being arranged with their longitudinal axes collinear and their larger basal surfaces parallel and adjacent to each other and separated by a gap.

2. The dielectric resonator radiator of claim 1 further comprising a longitudinal through hole.

3. The dielectric resonator radiator of claim 2 wherein said through hole is in the shape of first and second truncated conical hole portions, said first and second conical hole portions disposed in said first and second dielectric material portions, respectively, said first and second conical hole portions being inverted relative to the conical dielectric material portions within which they are disposed.

4. The dielectric resonator radiator of claim 1 wherein said gap comprises a vacuum.

5. The dielectric resonator radiator of claim 1 wherein said gap comprises a disc of dielectric material having a dielectric constant lower than a dielectric constant of said first and second dielectric material portions.

6. The dielectric resonator radiator of claim 5 wherein said disc comprises a material having a variable dielectric constant.

7. The dielectric resonator radiator of claim 1 further comprising an input coupler disposed in said gap for introducing electromagnetic energy into said radiator.

8. The dielectric resonator of claim 1 wherein said input coupler comprises a coupling loop.

9. The dielectric resonator radiator of claim 1 wherein said first and second resonator material portions are mirror images of each other.

10. A dielectric resonator radiator comprising a dielectric resonator body defining a longitudinal direction perpendicular to a direction of an electrical field of a fundamental mode of said resonator and a transverse direction parallel to said field, said resonator body having first and second longitudinal ends, an outer side wall connecting said first and second longitudinal ends, a cross-section in said transverse direction that decreases monotonically between an intermediate transverse plane passing through said resonator and said first longitudinal end and decreases monotonically between said intermediate transverse plane and said second longitudinal end and further comprising a transverse gap intermediate said first and second longitudinal ends.

11. The dielectric resonator radiator of claim 10 wherein said intermediate transverse plane and said gap are halfway between said first and second longitudinal ends.

12. The dielectric resonator radiator of claim 10 further comprising a longitudinal through hole.

13. The dielectric resonator radiator of claim 12 wherein said through hole is in the shape of first and second truncated conical hole portions, said first conical hole portion disposed between said intermediate transverse plane and said first end and having a cross-section in said transverse direction that increases monotonically between said intermediate transverse plane and said first longitudinal end and said second conical hole portion disposed between said intermediate transverse plane and said second end and having a cross-section in said transverse direction that increases monotonically between said intermediate transverse plane and said second longitudinal end.

14. The dielectric resonator radiator of claim 10 wherein said dielectric resonator body is formed of a material having a first dielectric constant and said gap comprises a disc of dielectric material having a dielectric constant lower than said first dielectric constant.

15. The dielectric resonator radiator of claim 10 further comprising an input coupler disposed in said gap for introducing electromagnetic energy into said radiator.

16. The dielectric resonator radiator of claim 11 wherein said dielectric resonator body comprises a mirror image about said longitudinal transverse plane.

17. A dielectric resonator radiator comprising:
a conical dielectric material body having a longitudinal axis, a larger basal surface, and a smaller basal surface transverse said longitudinal axis;
a first planar reflector adjacent and parallel to said larger basal surface and separated therefrom by a gap.

18. The dielectric resonator radiator of claim 17 further comprising a longitudinal through hole.

19. The dielectric resonator radiator of claim 18 wherein said through hole is in the shape of a truncated cone inverted relative to the conical dielectric material body.

20. The dielectric resonator radiator of claim 16 further comprising a second planar reflector perpendicular to said first planar reflector conical dielectric material body.

21. A dielectric resonator radiator comprising:
a conical dielectric material body having a longitudinal axis, a larger basal surface, and a smaller basal surface transverse said longitudinal axis;
a planar reflector parallel to said longitudinal axis and adjacent said conical dielectric material body.
